(19) United States
(12) Patent Application Publication
(10) Pub. No.: US 2006/0010770 A1
(43) Pub. Date: Jan. 19, 2006

(54) Pet door gasket assembly

(75) Inventor: William S. Groh, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 10/892,708

(22) Filed: Jul. 16, 2004

(51) Int. Cl. E05D 15/48

(52) U.S. Cl. 49/169

(57) ABSTRACT

A pet door gasket assembly adapted to provide a strong thermal, chemical, and mechanical bond between the gasket and the pet door flap. The gasket assembly incorporates a flexible, resilient, and permanently lubricated polymeric material chemically and thermally bonded to a rigid pet door flap. Further, the gasket is molded around series of pins extending from the faces of the rigid flap to provide a mechanical bond with the pet door flap.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention

The invention relates to a gasket assembly for a pet door. More specifically, this invention relates to an molded gasket assembly adapted to securely affix a weatherstripping material to a pet door flap.

2. Description of the Related Art

Conventional pet doors utilizing a rigid flap generally have a gasket or weatherstrip to seal the area between the flap and the pet door frame. Common materials used for the weatherstrip include a rubber gasket or fibrous flock material. Such weatherstripping materials are secured to the flap in a channel around the edge of the flap and held in place by friction, i.e., the gasket is “pinched” in the channel. Such a construction relies on a purely mechanical bond. In some cases, either or both of the weatherstrip and the channel include a shoulder to further resist the removal of the weatherstrip. Such weatherstripping options require additional labor to install as the require to separate pieces to be put together. However, such weatherstrips are still subject to falling off, being torn off, and the channel loaded with or the gasket covered with foreign objects, e.g., dirt and mud.

FIG. 3 illustrates another prior art weatherstripping configuration, such as is found in pet door. In the illustrated embodiment, the pet door flap 300 has a radial extension 302 about the perimeter. A polymeric weatherstripping material 304 is bonded to the extension 302. However, a weatherstrip secured in such a manner has only the connection with the bonding surface to resist removal. During the life of a pet door, the repeated stresses and the extreme environmental factors that are encountered degrade the bond between the pet door flap and the weatherstripping shown in FIG. 3. As the bond breaks down, the weatherstripping is freed to slide of the flap.

Accordingly, there is a need for a pet door gasket that is securely bonded to the pet door flap with sufficient structure to prevent removal even after years of continuous operation in extreme environmental conditions.

### BRIEF SUMMARY OF THE INVENTION

A pet door gasket assembly adapted to provide a strong thermal, chemical, and mechanical bond between the gasket and the pet door flap is shown and described. The gasket assembly incorporates a flexible, resilient, and permanently lubricated polymeric material chemically and thermally bonded to a rigid pet door flap. Further, the gasket is molded around series of pins extending from the faces of the rigid flap to provide a mechanical bond with the pet door flap. The lubricated gasket material resists wear and tear and offers reduced friction to allow for unhindered movement of the rigid flap while still providing a substantially weather-tight seal between the right flap and the pet door frame.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates a rigid pet door flap incorporating the gasket assembly of the present invention;

FIG. 2 illustrates a sectional view, taken at 2-2 of FIG. 1, of the gasket assembly of the present invention;

FIG. 3 illustrates a prior art pet door incorporating the closest known pet door weatherstripping configuration.

### DETAILED DESCRIPTION OF THE INVENTION

A pet door gasket assembly adapted to withstand continual operation and changing environmental conditions is shown in the figures and described herein. The general construction of a pet door is well known to those skilled in the art and, therefore, are not described in detail herein. Specifically, frames, flaps, closure mechanisms, locking mechanisms, and other common features are deemed to be within the purview of one of ordinary skill in the art. The pet door gasket assembly described herein is configured to allow a gasket to remain securely bonded to a pet door over time and in the presence of varying environment conditions. It will be understood by those skilled in the art that the pet door gasket assembly described herein can be used in various pet doors without departing from the scope and spirit of the present invention.

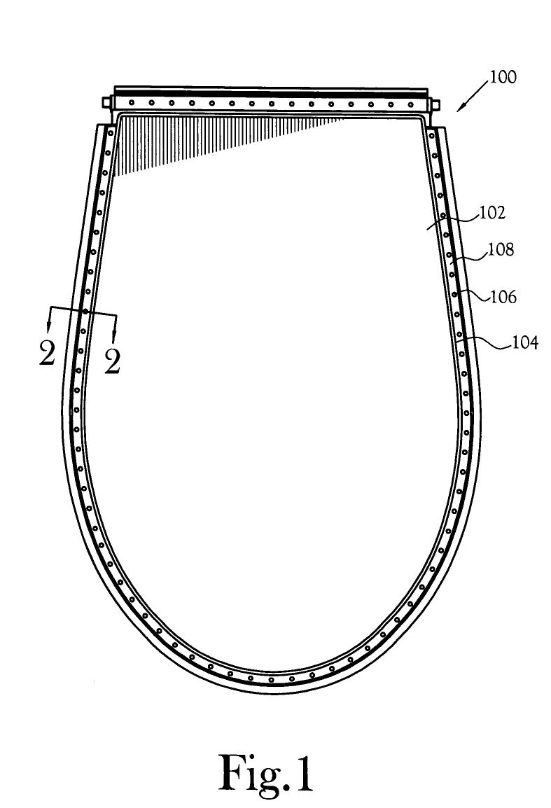

FIG. 1 illustrates a rigid flap for use in a pet door incorporating the gasket assembly 100 of the present invention. The rigid member 102 forming the flap has a raised lip 104 that follows the perimeter of the rigid member 102. The rigid member 102 and the lip 104 are fabricated from a substantially rigid material. The rigid member 102 is shaped to fit within an opening in a pet door flame (not shown). A plurality of pins 106 extend from each face of the rigid member 102 outside of the boundary defined by the lip 104. The pins 106 are also fabricated from a substantially rigid material. In practice, the rigid member 102, the lip 104, and the pins 106 are integrally molded in a single mold from the same material. A flexible and resilient gasket 108 is molded over the edge of the rigid member 102 outside the boundary defined by the lip 104 and around the pins 106.

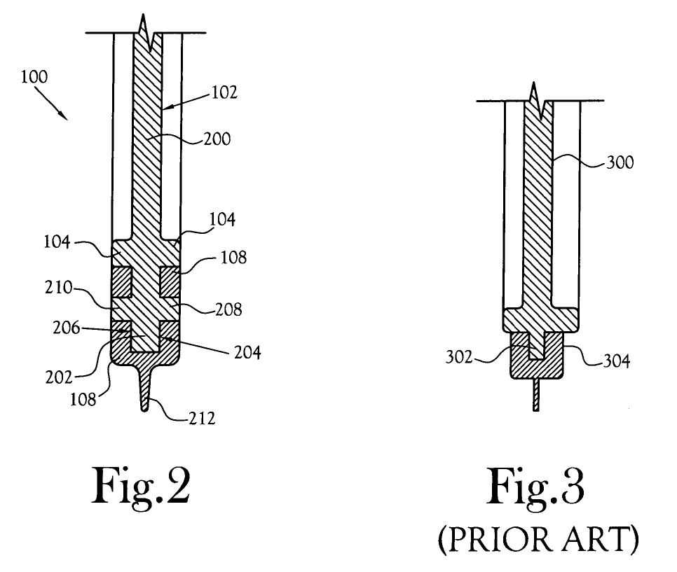

FIG. 2 illustrates a cross-section of an edge portion of the flap 100 taken through the gasket 108 and one of the pins 106. The rigid member 102 has two opposing faces 204, 206. A central portion 200 of the rigid member 102 lies within the bounds of the raised lip 104 and an edge extension 202 of the rigid member 102 lies outside the bounds of the raised lip 104. From the first face 204, a first pin 208 extends outwardly. Similarly, a second pin 210 extends in an opposite direction from the opposing face 206. In the illustrated embodiment, the opposing pins 208, 210 are axially aligned; however, those skilled in the art will recognize that the opposing pins 208, 210 could be offset from one another without departing from the scope and spirit of the present invention. The pins shown in FIGS. 1 and 2 are illustrated as cylindrical posts; however, those skilled in the art will recognize that other geometries for the pins can be used without departing from the scope and spirit of the present invention.

In one embodiment, the gasket 108 is over-molded around the extended edge 202 and the pins 208, 210, generally occupying the area outside of the raised lip and forming wiping edge 212, which cooperates with the pet door frame to form a substantially weather-tight seal. The over-molding process provides both a chemical and thermal bond between the gasket 108 and the rigid member 102. The inclusion of the pins 208, 210 adds the enhancement of a mechanical bond between the gasket 108 and the rigid member 102.

The gasket 108 is fabricated from a flexible and resilient material. While there are several polymeric materials that are suitable for the construction of the gasket 108, the utilization of a thermoplastic elastomer (TPE) compounded with a permanent lubricant reduces friction between the gasket 108 and the pet door frame. Further, a gasket 108 fabricated from a lubricated polymeric material has increased resistance to wear and tearing. Alternatively, a thermoplastic vinyl (TPV) material can be used to construct the gasket without departing from the scope and spirit of the present invention.

A pet door gasket assembly adapted to provide a strong thermal, chemical, and mechanical bond between the gasket and the pet door flap has been shown and described. The gasket assembly incorporates a flexible, resilient, and permanently lubricated polymeric material chemically and thermally bonded to a rigid pet door flap. Further, the gasket is molded around series of pins extending from the faces of the rigid flap to provide a mechanical bond with the pet door flap. The lubricated gasket material resists wear and tear and offers reduced friction to allow for unhindered movement of the rigid flap while still providing a substantially weather-tight seal between the right flap and the pet door frame.

While the present invention has been illustrated by description of several embodiments and while the illustrative embodiments have been described in detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A gasket assembly for use in a pet door, said gasket assembly comprising:
a flap having a pair of opposing faces and a perimeter;
a plurality of pins extending from each of said pair of opposing faces of said flap, said plurality of pins arranged along said perimeter of said flap;
a gasket carried by said flap, said gasket being chemically, mechanically, and thermally bonded to said flap.

2. The gasket assembly of claim 1 wherein said gasket is fabricated from a polymeric material which is both flexible and resilient.

3. The gasket assembly of claim 1 wherein said gasket is fabricated from a polymeric material which is permanently lubricated.

4. The gasket assembly of claim 1 wherein said flap further includes a raised lip following said perimeter of said flap.

5. The gasket assembly of claim 1 wherein said flap further includes a raised lip following said perimeter of said flap, said plurality of pins being located on said flap outside of said raised lip.

6. The gasket assembly of claim 1 wherein said flap further includes a raised lip following said perimeter of said flap and wherein said plurality of pins are located on said flap outside of said raised lip, said gasket molded around said plurality of pins.

7. A gasket assembly for use in a pet door, said gasket assembly comprising:
a flap having a pair of opposing faces and a perimeter, said flap being substantially rigid, said flap having a raised lip substantially following said perimeter;
a plurality of pins extending from each of said pair of opposing faces of said flap, said plurality of pins arranged along said perimeter of said flap and outside of said raised lip;
a gasket bonded to each of said pair of opposing faces of said flap, said gasket encircling each of said plurality of pins, said gasket being fabricated from a polymeric material which is flexible, resilient, and permanently lubricated.

8. A pet door comprising:
a frame for bounding an opening providing ingress and egress to an animal;
a flap substantially filling said opening, said flap being substantially rigid, said flap pivoting with said frame, said flap having a pair of opposing faces and a perimeter, said flap having a raised lip substantially following said perimeter;
a plurality of pins extending from each of said pair of opposing faces of said flap, said plurality of pins arranged along said perimeter of said flap and outside of said raised lip;
a gasket bonded to each of said pair of opposing faces of said flap, said gasket being molded around each of said plurality of pins, said gasket being fabricated from a polymeric material which is flexible, resilient, and permanently lubricated.
